(19) United States
(12) Patent Application Publication
(10) Pub. No.: US 2026/0083604 A1
(43) Pub. Date: Mar. 26, 2026

(54) PERSONAL MOBILITY VEHICLE

(71) Applicant: Zijun LI, Shenzhen (CN)

(72) Inventors: Zijun LI, Shenzhen (CN); Xiangping LIU, Shenzhen (CN)

(21) Appl. No.: 19/197,984

(22) Filed: May 3, 2025

(30) Foreign Application Priority Data
May 9, 2024 (CN) 202410571847.9

(51) Int. Cl. A61G 5/08; A61G 5/04; A61G 5/10; A61G 5/12

(52) U.S. Cl. CPC A61G 5/0841; A61G 5/045; A61G 5/0866; A61G 5/0883; A61G 5/1089; A61G 5/122; A61G 5/125; A61G 5/128

(57) ABSTRACT

This application relates to a personal mobility vehicle. The vehicle comprises: a front leg unit, including a front vehicle body and a front wheel mounted thereon; a rear leg unit, including a rear vehicle body and a rear wheel mounted thereon; a seat unit pivotally connected to the front vehicle body and/or rear vehicle body; a backrest unit including a backrest pivotally connected to the seat unit; and a slider on the rear vehicle body, pivotally connected to the seat unit and/or backrest unit. As the slider moves, the front vehicle body and rear vehicle body move apart or toward each other, while the seat unit rotates. The vehicle facilitates folding and unfolding, improving the user experience.

### CROSS-REFERENCE TO RELATED APPLICATIONS

This application claims priority under 35 U.S.C. § 119(a) to Chinese Patent Application No. 202410571847.9, filed on May 9, 2024, which is hereby incorporated by reference herein in its entirety.

### TECHNICAL FIELD

The present application relates to the field of mobility devices, particularly to a personal mobility vehicle.

### BACKGROUND ART

Electric personal mobility vehicles utilize motors to drive wheels mounted beneath the vehicle body, allowing the user to ride them. Some existing mobility vehicles feature foldability for storage when not in use. However, their substantial overall weight and cumbersome folding and unfolding procedures are time-consuming and labor-intensive.

### SUMMARY

To address these issues, the present application provides a personal mobility vehicle with simplified folding and unfolding.

In one aspect, the personal mobility vehicle comprises:
a front leg unit, including a front vehicle body and a front wheel mounted thereon;
a rear leg unit, including a rear vehicle body and a rear wheel mounted thereon;
a seat unit pivotally connected to the front vehicle body and/or rear vehicle body;
a backrest unit including a backrest pivotally connected to the seat unit;
a slider installed on the rear vehicle body and pivotally connected to the seat unit and/or backrest unit;
whose sliding movement causes the front vehicle body and the rear vehicle body to move toward or away from each other while simultaneously inducing rotation of the seat unit.

In some embodiments, the seat unit includes a limiting mechanism configured to restrict rotation of the backrest relative to the seat unit within a predetermined range.

In some embodiments: the front vehicle body is pivotally connected to the rear vehicle body; and the seat unit includes a first pivot shaft connected to the front vehicle body and a second pivot shaft connected to the slider.

In some embodiments, the backrest unit further comprises a backrest link with one end pivotally connected to the backrest, and the other pivotally connected to the front vehicle body and/or rear vehicle body, said backrest link being configured to drive rotation of the backrest.

In some embodiments, the seat unit and/or backrest are pivotally connected to the slider.

In some embodiments, the seat unit is pivotally connected to the front vehicle body, the slider, and the backrest.

In some embodiments, the seat unit, the slider, and the backrest are coaxially pivoted.

In some embodiments: the backrest is pivotally connected to the slider; and the seat unit is pivotally connected to both the front vehicle body and the backrest.

In some embodiments: the slider is pivotally connected to the backrest unit; the end of the backrest link distal from the backrest is pivotally connected to the front vehicle body; and the seat unit has one end pivotally connected to the backrest and the other pivotally connected to the front vehicle body and/or rear vehicle body.

In some embodiments, the vehicle further comprises a drive mechanism configured to drive movement of the slider relative to the rear vehicle body.

In some embodiments, the rear leg unit further comprises an armrest rotatably connected to the slider.

In some embodiments, the rear leg unit further comprises a limiting mechanism configured to restrict rotation of the armrest relative to the slider within a predetermined range.

In some embodiments, the vehicle further comprises a control panel installed on the armrest and connected to the drive mechanism.

In some embodiments, the vehicle further comprises a controller mounted on the rear vehicle body and electrically connected to the drive mechanism;

The rear vehicle body has a sliding groove, the slider has a first through-hole, the armrest has a second through-hole, and the vehicle further includes a transmission line having: one end connected to the controller, and the other end sequentially passing through the sliding groove, the first through-hole, and the second through-hole to connect to the control panel.

In some embodiments, the transmission line includes a helical section installed within the rear vehicle body.

In some embodiments, the vehicle further comprises a locking mechanism configured to restrict movement of the slider relative to the rear vehicle body.

In some embodiments, the rear leg unit further comprises an anti-tip wheel configured to contact the ground when the vehicle is folded.

During folding and unfolding, the front leg unit, rear leg unit, and seat unit move synchronously, simplifying operations and enhancing the user experience.

### BRIEF DESCRIPTION OF THE DRAWINGS

To more clearly illustrate the technical solutions of the present application, the accompanying drawings required for describing the embodiments are briefly introduced below. Obviously, the drawings in the following description merely show some embodiments of the present application. For those skilled in the art, other drawings may be derived from these drawings without departing from the scope of protection claimed in this application.

FIG. 1 is the first schematic diagram of the personal mobility vehicle according to an embodiment of the present application;

FIG. 2 is the second schematic diagram of the personal mobility vehicle according to an embodiment of the present application;

FIG. 3 is a schematic diagram showing the personal mobility vehicle in folded state according to an embodiment of the present application;

FIG. 4 is a schematic diagram of the first implementation of the personal mobility vehicle according to an embodiment of the present application;

FIG. 5 is a schematic diagram of the second implementation of the personal mobility vehicle according to an embodiment of the present application;

FIG. 6 shows personal mobility vehicle illustrated in FIG. 5 in folded state;

FIG. 7 is a schematic diagram of the third implementation of the personal mobility vehicle according to an embodiment of the present application;

FIG. 8 shows the personal mobility vehicle illustrated in FIG. 7 in folded state;

FIG. 9 is a schematic diagram of the fourth implementation of the personal mobility vehicle according to an embodiment of the present application;

FIG. 10 is a schematic diagram of the fifth implementation of the personal mobility vehicle according to an embodiment of the present application;

FIG. 11 shows the personal mobility vehicle illustrated in FIG. 10 in folded state;

FIG. 12 is the third schematic diagram of the personal mobility vehicle according to an embodiment of the present application;

FIG. 13 is a schematic diagram showing rotation of the armrest according to an embodiment of the present application;

FIG. 14 is an enlarged view of portion A in FIG. 13;

FIG. 15 is the fourth schematic diagram of the personal mobility vehicle according to an embodiment of the present application;

FIG. 16 is an enlarged view of portion B in FIG. 15;

FIG. 17 is a schematic diagram of the locking mechanism according to an embodiment of the present application.

### DETAILED DESCRIPTION

The technical solutions of the present application will be clearly and completely described below with reference to the accompanying drawings in the embodiments of the present application. Obviously, these are only some of the embodiments of the present application, not all possible embodiments. Based on the embodiments in the present application, all other embodiments obtained by those of ordinary skill in the art without creative work shall fall within the scope of the present application.

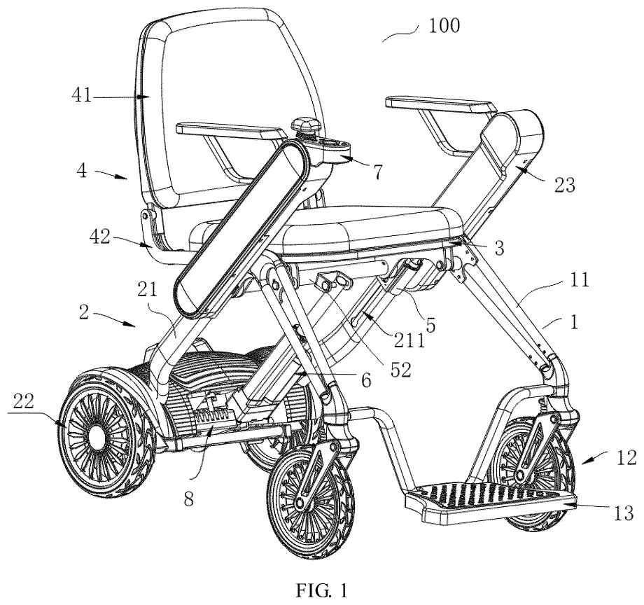

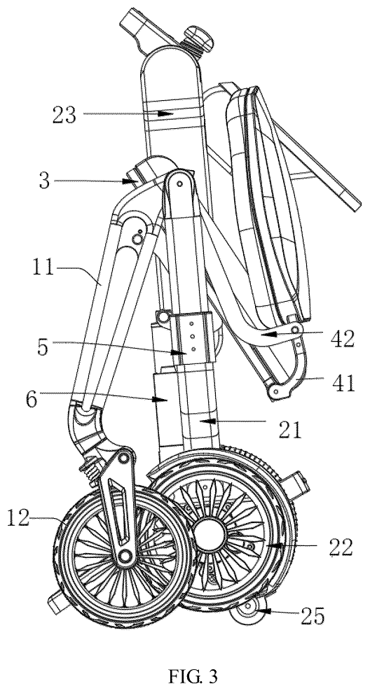

As shown in FIGS. 1, 2 and 3, an embodiment of the present application provides a personal mobility vehicle 100. The personal mobility vehicle 100 includes a front leg unit 1, rear leg unit 2, seat unit 3, backrest unit 4, and slider 5. It is convenient to fold and unfold the personal mobility vehicle 100.

The front leg unit 1 includes a front vehicle body 11 and front wheel 12. The front wheel 12 is located at the bottom of the front vehicle body 11. Optionally, the front wheel 12 is a caster wheel or an omnidirectional wheel. The front leg unit 1 further includes a footrest 13, set on the front vehicle body 11.

The rear leg unit 2 includes a rear vehicle body 21 and rear wheel 22. The rear wheel 22 is set at the bottom of the rear vehicle body 21. Optionally, the rear leg unit 2 further includes a motor, used to drive the rear wheel 22 to rotate.

The user sits on the seat unit 3 in the unfolded state. The seat unit 3 is pivotally connected to the front vehicle body 11 and/or rear vehicle body 21. For example, the seat unit 3 may be pivotally connected to the top of the front vehicle body 11, or pivotally connected to the top of the rear vehicle body 21, or pivotally connected to both the front vehicle body 11 and rear vehicle body 21.

The backrest unit 4 is connected to the seat unit 3. The user lean against the backrest unit 4 in the unfolded state. The backrest unit 4 includes a backrest 41, which is pivotally connected to the seat unit 3, so that the backrest 41 can be folded or unfolded. For example, when folding, the top of the backrest 41 rotates toward the seat unit 3; and when unfolding, the top of the backrest 41 rotates away from the seat unit 3.

The slider 5 is set on the rear vehicle body 21. For example, the slider 5 can move along the outer wall of the rear vehicle body 21 toward either the top or bottom of the rear vehicle body 21. The slider 5 is pivotally connected to the seat unit 3 and/or backrest unit 4. For example, the slider 5 may be pivotally connected to the seat unit 3, or pivotally connected to the backrest unit 4, or pivotally connected to both the seat unit 3 and backrest unit 4.

As the slider 5 moves, the front vehicle body 11 and rear vehicle body 21 move away from or toward each other, while the seat unit 3 rotates, thereby unfolding or folding the personal mobility vehicle 100. As the slider 5 moves toward the top of the rear vehicle body 21, the front vehicle body 11 and rear vehicle body 21 move away from each other, simultaneously driving the seat unit 3 to gradually rotate to an approximately horizontal state, unfolding the personal mobility vehicle 100. As the slider 5 moves toward the bottom of the rear vehicle body 21, the front vehicle body 11 and rear vehicle body 21 move toward each other, while driving the seat unit 3 to rotate by tilting its front end upward, folding the personal mobility vehicle 100. The backrest 41 may rotate synchronously with the seat unit 3, or may be folded and unfolded independently.

When the personal mobility vehicle 100 of this embodiment is folded or unfolded, the front leg unit 1 and seat unit 3 simultaneously move toward or away from the rear leg unit 2, making folding and unfolding simple and user-friendly.

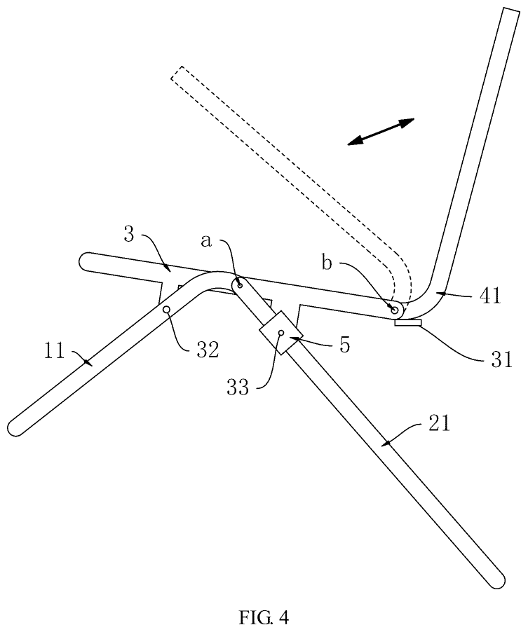

As shown in FIG. 4, in some embodiments, the backrest 41 is pivotally connected to the seat unit 3 and can be folded and unfolded independently. The rear end of the seat unit 3 has a limiter 31. As the backrest 41 is unfolded, it abuts against the limiter 31, which then restricts further rotation of the backrest 41, thereby keeping the rotation angle of the backrest 41 relative to the seat unit 3 within a predetermined range. The arrow in FIG. 4 indicates the rotation direction of the backrest 41.

In some embodiments, the front vehicle body 11 is pivotally connected to the rear vehicle body 21, with point A being the pivot connection point between them, and point B being the pivot connection point between the seat unit 3 and backrest 41. The seat unit 3 has a first pivot shaft 32 and second pivot shaft 33, where the first pivot shaft 32 connects to the front vehicle body 11 and the second pivot shaft 33 connects to the slider 5. As the slider 5 moves toward the bottom of the rear vehicle body 21, the bottom of the front vehicle body 11 rotates toward the rear vehicle body 21, while the front end of the seat unit 3 tilts upward, causing the top of the backrest 41 to rotate toward the seat unit 3 to fold the personal mobility vehicle 100.

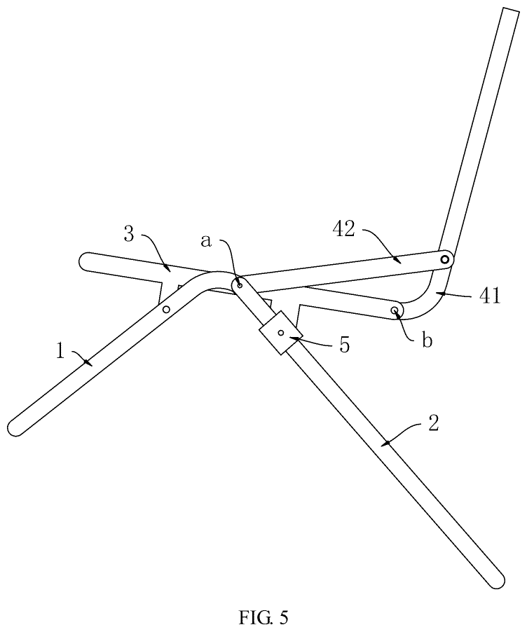

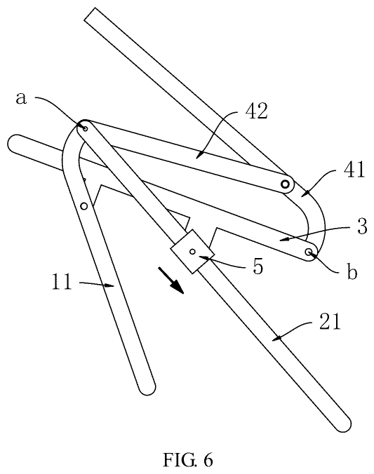

As shown in FIGS. 5 and 6, in some embodiments, the backrest unit 4 further includes a backrest link 42. One end of the backrest link 42 is pivotally connected to the backrest 41, while the other end is pivotally connected to the front vehicle body 11 and/or rear vehicle body 21. The backrest link 42 can drive the rotation of the backrest 41. Taking the rear vehicle body 21 as stationary for example, the backrest link 42 drives the backrest 41 to rotate. As the personal mobility vehicle 100 folded or unfolded, the front vehicle body 11, seat unit 3, and backrest 41 rotate simultaneously, facilitating the user to fold or unfold the vehicle. The arrow in FIG. 6 indicates the motion direction of the slider 5.

In some embodiments, when the personal mobility vehicle 100 is unfolded, the backrest link 42 is positioned above the seat unit 3, or substantially flush with the edge of the seat unit 3. The seat unit 3 and/or backrest 41 are pivotally connected to the slider 5.

As shown in FIG. 5, in some embodiments, the seat unit 3 is pivotally connected to the front vehicle body 11, slider 5, and backrest 41 from front to rear. Optionally, the backrest link 42 may also be coaxially pivoted with the front vehicle body 11 and rear vehicle body 21 at point A. As the slider 5 moves toward the bottom end of the rear vehicle body 21, the front vehicle body 11, seat unit 3, and backrest 41 rotate simultaneously to fold the personal mobility vehicle 100.

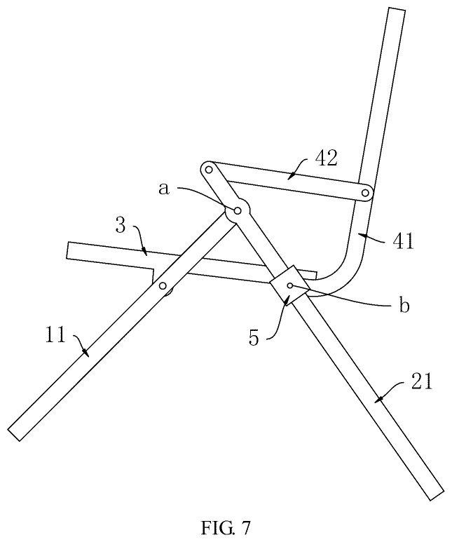

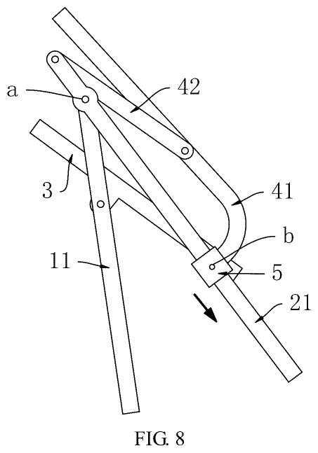

As shown in FIGS. 7 and 8, in some embodiments, the seat unit 3 is pivotally connected to the slider 5, backrest 41, and front vehicle body 11, while the front vehicle body 11 is pivotally connected to the rear vehicle body 21. The top of the rear vehicle body 21 extends upward beyond point A, and the end of the backrest link 42 is pivotally connected to the top of the rear vehicle body 21. As the slider 5 moves toward the bottom of the rear vehicle body 21, the front vehicle body 11, seat unit 3, and backrest 41 rotate simultaneously to fold the personal mobility vehicle 100. The arrow in FIG. 8 indicates the motion direction of the slider 5.

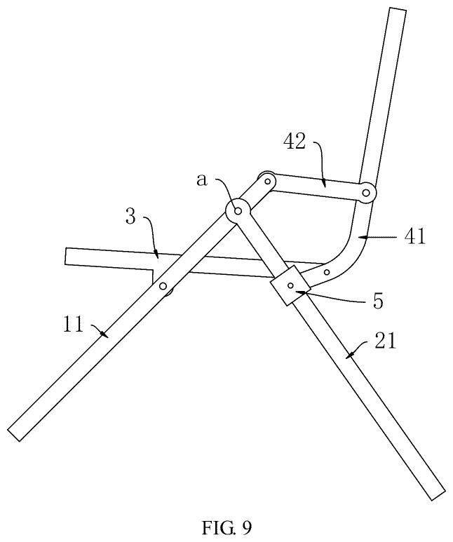

As shown in FIG. 9, in some embodiments, the front vehicle body 11 is pivotally connected to the rear vehicle body 21, with the top of the front vehicle body 11 extending upward beyond point A, and the end of the backrest link 42 pivotally connected to the top of the front vehicle body 11.

As shown in FIG. 7, in some embodiments, the seat unit 3, slider 5, and backrest 41 are coaxially pivoted at point B.

As shown in FIG. 9, in some embodiments, the backrest 41 is pivotally connected to the slider 5, while the seat unit 3 is pivotally connected to both the front vehicle body 11 and backrest 41.

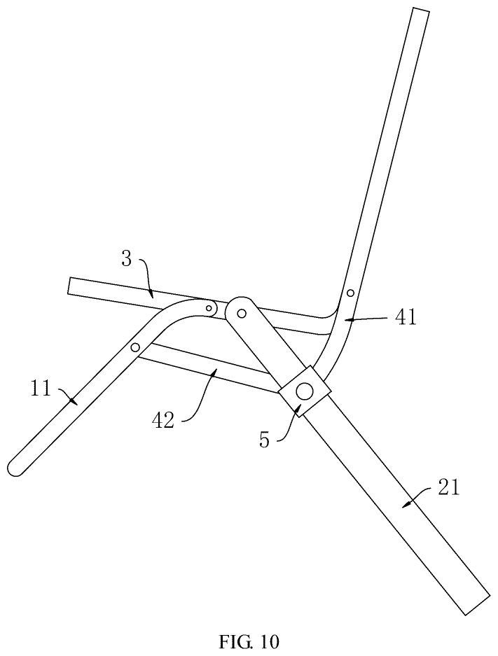

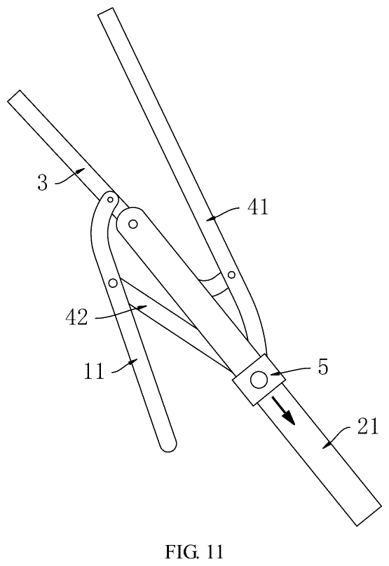

As shown in FIGS. 10 and 11, in some embodiments, when the personal mobility vehicle 100 is unfolded, the backrest link 42 is positioned below the seat unit 3. The slider 5 is pivotally connected to the backrest unit 4—for example, the slider 5, backrest 41, and backrest link 42 are coaxially pivoted. The end of the backrest link 42 away from the backrest 41 is pivotally connected to the front vehicle body 11. One end of the seat unit 3 is pivotally connected to the backrest 41, while the other end is pivotally connected to the front vehicle body 11 and/or rear vehicle body 21. Alternatively, the seat unit 3 may be pivotally connected to both the front vehicle body 11 and rear vehicle body 21, or the seat unit 3, front vehicle body 11, and rear vehicle body 21 may be coaxially pivoted. As the slider 5 moves toward the bottom of the rear vehicle body 21, the front vehicle body 11, seat unit 3, and backrest 41 rotate simultaneously to fold the personal mobility vehicle 100. The arrow in FIG. 11 indicates the motion direction of the slider 5.

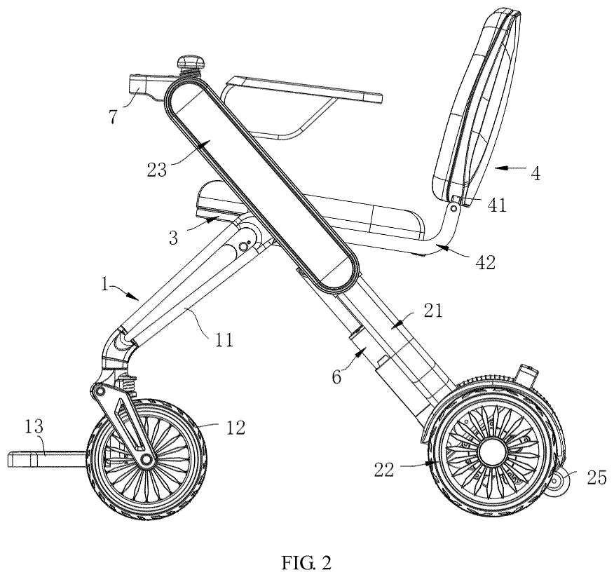

As shown in FIGS. 1 and 2, in some embodiments, the personal mobility vehicle 100 further includes a drive mechanism 6, such as an electric actuator. The drive mechanism 6 can drive the slider 5 to move relative to the rear vehicle body 21. Optionally, one end of the drive mechanism 6 is pivotally connected to the rear vehicle body 21, while the other end is connected to the slider 5 via an adapter 52 to drive the slider 5 to move relative to the rear vehicle body 21. The personal mobility vehicle 100 unfolds as the slider 5 moves toward the top of the rear vehicle body 21, and folds as the slider 5 moves toward the bottom. The drive mechanism 6 provides power for folding and unfolding, enhancing the user experience.

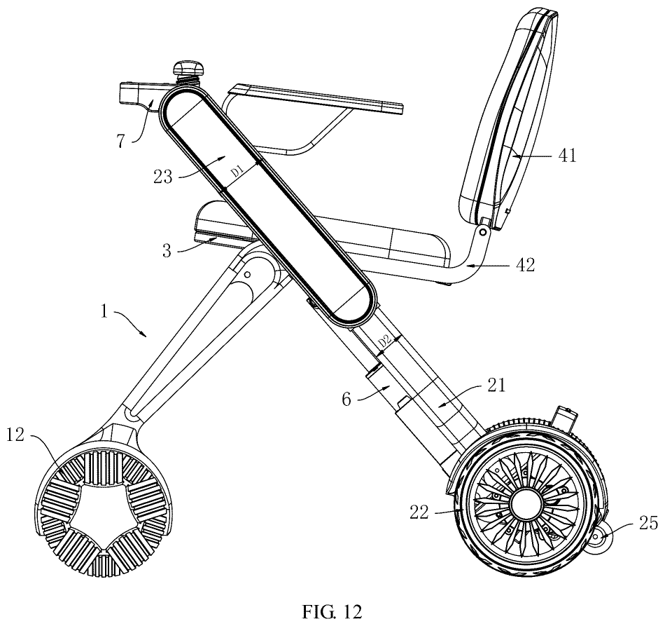

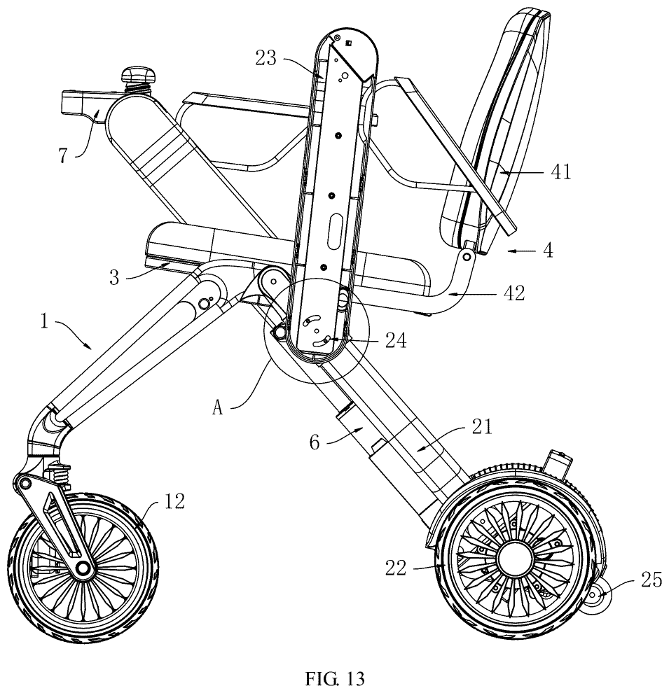

As shown in FIGS. 12 and 13, in some embodiments, the rear leg unit 2 further includes an armrest 23 rotatably connected to the slider 5. As the slider 5 moves toward the top of the rear vehicle body 21, it drives the armrest 23 to rise, facilitating user access. As the slider 5 moves toward the bottom of the rear vehicle body 21, it drives the armrest 23 to descend and retract. The width D1 of the armrest 23 is greater than the width D2 of the rear vehicle body 21, providing protective coverage for the rear vehicle body 21 when retracted.

In some embodiments, the rear leg unit 2 further includes a limiting mechanism 24 configured to restrict the rotation angle of the armrest 23 relative to the slider 5 to within a predetermined range.

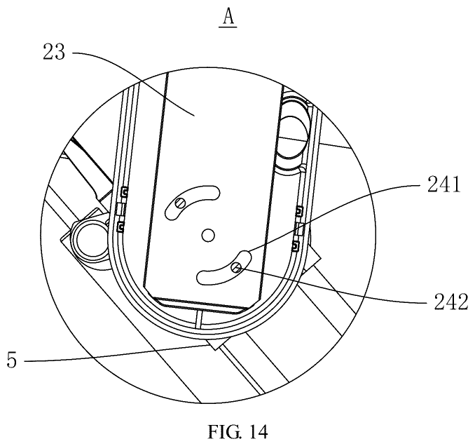

As shown in FIG. 14, the limiting mechanism 24 may optionally include a first limiting member 241 and second limiting member 242. The first limiting member 241 is set on the armrest 23—for example, it may be an arc groove whose center is located on the rotation axis of the armrest 23. The second limiting member 242 is set on the slider 5 and corresponds to the first limiting member 241—for example, it may be a limit pin inserted into the arc groove to restrict the rotational range of the armrest 23 relative to the slider 5.

As shown in FIG. 12, in some embodiments, the personal mobility vehicle 100 further includes a control panel 7. The control panel 7 is set at the top of the armrest 23 and is connected to the drive mechanism 6. The control panel 7 can control the operation of the drive mechanism 6 to fold and unfold the vehicle. Optionally, the control panel 7 is also connected to the drive motor of the rear wheel 22 to control the vehicle movement. The rear vehicle body 21 houses a battery to power both the drive mechanism 6 and the rear wheel motor.

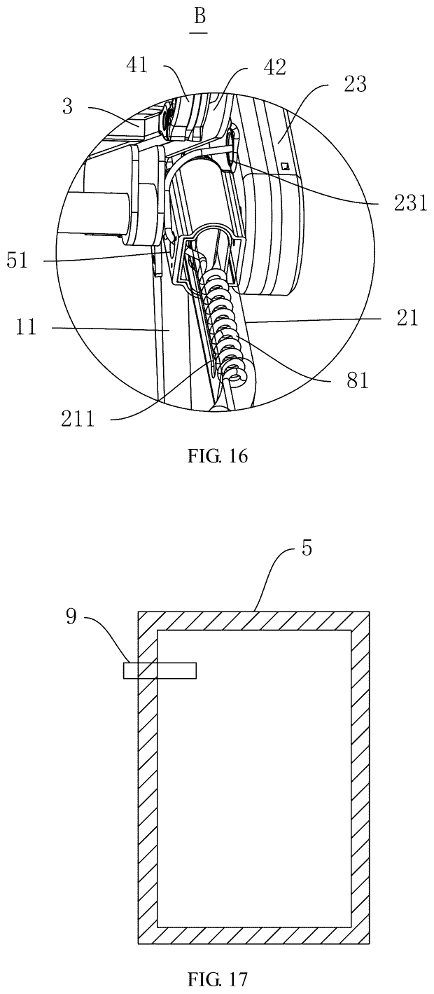

As shown in FIGS. 1, 15 and 16, the vehicle further includes a controller 8, optionally set on the rear vehicle body 21. The controller 8 is electrically connected to the drive mechanism 6 and controls its operation.

The side wall of the rear vehicle body 21 has a sliding groove 211 connected to its internal cavity and extending along its length. The slider 5 has a first through-hole 51, while the armrest 23 has a second through-hole 231. The vehicle also includes a transmission line 81 with one end connected to the controller 8, and the other end sequentially passing through the sliding groove 211, first through-hole 51, and second through-hole 231 to the control panel 7, establishing communication between them. The control panel 7 sends control signals to the controller 8, which then operates the drive mechanism 6 accordingly.

In some embodiments, the transmission line 81 includes a helical segment housed within the rear vehicle body 21. As the slider 5 moves, the transmission line 81 can extend or retract accordingly.

As shown in FIG. 17, in some embodiments, the vehicle also includes a locking mechanism 9 to restrict movement of the slider 5 relative to the rear vehicle body 21. For example, the locking mechanism 9 may include a spring-loaded pin (using conventional technology) mounted on the side wall of the slider 5. The rear vehicle body 21 has corresponding first and second pin holes. At the upper travel limit of the slider 5, the pin engages the first hole to maintain the unfolded state; at the lower limit, it engages the second hole to maintain the folded state, facilitating manual operation.

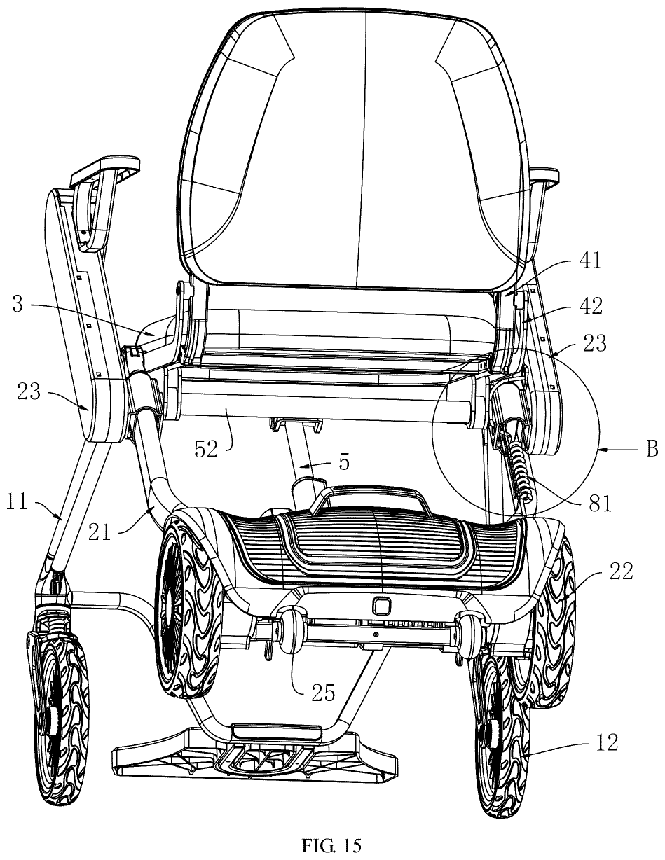

As shown in FIGS. 12 and 15, in some embodiments, the rear leg unit 2 further includes an anti-tip wheel 25 mounted on the rear vehicle body 21. In unfolded state, with both front 12 and rear 22 wheels grounded, the anti-tip wheel 25 remains elevated. If the vehicle tilts rearward while lifting the front wheel 12, the anti-tip wheel 25 contacts the ground to prevent excessive tilting, enhancing safety. Optionally, when folded, the front wheel 12 and anti-tip wheel 25 both contact the ground, while the rear wheel 22 lifts.

When folding, the vehicle's front leg unit 1, seat unit 3, and backrest unit 4 converge toward the rear leg unit 2 like an umbrella, simplifying operation and improving the user experience.

In the above descriptions of the embodiments, specific examples were used to explain the principles and implementations of this application, which serve only to facilitate understanding of the technical solutions and core concepts. Therefore, any modifications or variations made by those skilled in the art based on the concepts of this application within its specific implementation contexts shall fall within the scope of this application. In summary, this specification should not be construed as limiting the application of the device described herein.

What is claimed is:

1. A personal mobility vehicle, comprising:
a front leg unit including a front vehicle body and a front wheel mounted thereon;
a rear leg unit including a rear vehicle body and a rear wheel mounted thereon;
a seat unit pivotally connected to the front vehicle body and/or the rear vehicle body;
a backrest unit including a backrest pivotally connected to the seat unit;
a slider slidably disposed on the rear vehicle body and pivotally connected to the seat unit and/or backrest unit;
where a sliding movement of the slider causes the front vehicle body and the rear vehicle body to move toward or away from each other while simultaneously inducing rotation of the seat unit.

2. The vehicle according to claim 1, whose seat unit includes a limiting mechanism configured to restrict rotation of the backrest relative to the seat unit within a predetermined range.

3. The vehicle according to claim 2, wherein: the front vehicle body is pivotally connected to the rear vehicle body; and the seat unit includes a first pivot shaft connected to the front vehicle body and a second pivot shaft connected to the slider.

4. The vehicle according to claim 1, wherein the backrest unit further comprises a backrest link having one end pivotally connected to the backrest and another end pivotally connected to the front vehicle body and/or rear vehicle body, said backrest link being configured to allow rotation of the backrest.

5. The vehicle according to claim 4, wherein the seat unit and/or the backrest is pivotally connected to the slider.

6. The vehicle according to claim 5, wherein the seat unit is pivotally connected to the front vehicle body, the slider, and the backrest.

7. The vehicle according to claim 6, wherein the seat unit, the slider, and the backrest are coaxially pivoted.

8. The vehicle according to claim 5, wherein: the backrest is pivotally connected to the slider; and the seat unit is pivotally connected to both the front vehicle body and the backrest.

9. The vehicle according to claim 4, wherein: the slider is pivotally connected to the backrest unit; the end of the backrest link distal from the backrest is pivotally connected to the front vehicle body; and the seat unit has one end pivotally connected to the backrest and the other pivotally connected to the front vehicle body and/or rear vehicle body.

10. The vehicle according to claim 1, further comprising a drive mechanism configured to drive movement of the slider relative to the rear vehicle body.

11. The vehicle according to claim 10, wherein the rear leg unit further comprises an armrest rotatably connected to the slider.

12. The vehicle according to claim 11, whose rear leg unit further comprises a limiting mechanism configured to restrict rotation of the armrest relative to the slider within a predetermined range.

13. The vehicle according to claim 11, further comprising a control panel disposed on the armrest and communicatively coupled to the drive mechanism.

14. The vehicle according to claim 13, further comprising: a controller installed on the rear and electrically connected to the drive mechanism;
wherein: the rear vehicle body includes a sliding groove; the slider includes a first through-hole; the armrest includes a second through-hole; and the vehicle further comprises a transmission line with one end connected to the controller, and the other sequentially passing through the sliding groove, the first through-hole, and the second through-hole to connect to the control panel.

15. The vehicle according to claim 14, wherein the transmission line includes a helical segment housed within the rear vehicle body.

16. The vehicle according to claim 1, further comprising a locking mechanism configured to restrict movement of the slider relative to the rear vehicle body.

17. The vehicle according to claim 1, whose rear leg unit further comprises an anti-tip wheel configured to contact the ground when the vehicle is in a folded state.
